(19) United States
(12) Patent Application Publication
(10) Pub. No.: US 2008/0120205 A1
(43) Pub. Date: May 22, 2008

(54) Automatically processing inventory discrepancies

(76) Inventors: John Michael Hoopes, Washington, IL (US); Douglas Clifford Meyer, Morton, IL (US); Alida Rae Calhoun, Pekin, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/589,968

(22) Filed: Oct. 31, 2006

(51) Int. Cl. G06Q 10/00

(52) U.S. Cl. 705/28

(57) ABSTRACT

A method is disclosed that provides for automated processing of inventory discrepancies. In one embodiment, the method includes identifying an inventory discrepancy between an expected quantity of an inventory item and an actual quantity of the inventory item. The method further includes generating a discrepancy record based on the inventory discrepancy. The discrepancy record may include a plurality of data fields. In addition, the method includes evaluating one or more of the plurality of data fields and determining a priority for the discrepancy record based on the evaluation.

### TECHNICAL FIELD

The present disclosure relates generally to a system and method for processing inventory, and more particularly, to systems and methods for automatically processing inventory discrepancies.

### BACKGROUND

Businesses often forecast and maintain a stock of inventory to accommodate an expected demand for the items that they sell and/or utilize. The type and quantity of items in the inventory is conventionally maintained by inventory management tools, such as, for example, databases, spreadsheets, and the like. By maintaining a stock of items in an inventory location, a business has quick access to the inventory location in order to retrieve a desired item. However, this type of inventory management may lead to inventory discrepancies when the number of items actually located in an inventory location is not the same as the number of items listed by inventory management tools.

Inventory discrepancies may occur for many reasons, such as the non-receipt of merchandise, shipping delays, incorrect shipment, misdirected shipments, items received but stocked in the wrong location, and the like. Thus, inventory discrepancies may require a significant amount of human intervention to identify, track, and correct. In addition, inventory items that cannot be accounted for may result in a financial loss for a business and a business may be at a disadvantage because it does not have the right item at the right time.

Systems and methods have been created to compare actual inventory values with model inventory values to determine if an overage or shortage of inventory exists. One such example is U.S. Pat. No. 5,884,300 (the '300 patent) issued on Mar. 16, 1999 to Brockman. The '300 patent discloses an inventory pipeline management system that establishes inventory levels on a product-by-product basis. According to the '300 patent, a value validation and discrepancy reporting unit identifies discrepancies between calculated and actual product inventory data and generates management reports.

Although the system and method of the '300 patent allows a business to flag discrepancies and generate corresponding reports, the system and method do not offer a way to generate a discrepancy report to initiate action and then to track and update the status of the discrepancy report to resolution. Thus, the solution of the '300 patent does not provide mechanisms to automatically process and track inventory discrepancies to a point of convergence between the actual and expected inventory data.

The disclosed embodiments are directed to overcoming one or more of the problems set forth above.

### SUMMARY OF THE INVENTION

In one aspect, the present disclosure is directed to a method for automated processing of inventory discrepancies. The method identifies an inventory discrepancy between an expected quantity of an inventory item and an actual quantity of the inventory item. The method further generates a discrepancy record based on the inventory discrepancy. In one embodiment, the discrepancy record includes a plurality of data fields. In addition, the method evaluates one or more of the plurality of data fields and determines a priority for the discrepancy record based on the evaluation.

In another aspect, the present disclosure is directed to a computer-readable medium, including instructions for performing a method, when executed by a processor, for automated processing of inventory discrepancies. The method identifies an inventory discrepancy between an expected quantity of an inventory item and an actual quantity of the inventory item. The method further generates a discrepancy record based on the inventory discrepancy. In one embodiment, the discrepancy record includes a plurality of data fields. In addition, the method evaluates one or more of the plurality of data fields and determines a priority for the discrepancy record based on the evaluation.

In another aspect, the present disclosure is directed to a system for automated processing of inventory discrepancies. The system includes at least one memory storing data and instructions and at least one processor configured to access the memory. The at least one processor is further configured to, when executing instructions, generate a discrepancy record based on the inventory discrepancy and generate a list of discrepancy records, In one embodiment, the discrepancy record includes a plurality of data fields and the list of discrepancy records includes one or more discrepancy records. In addition, the processor is configured to evaluate one or more of the plurality of data fields for each of the discrepancy records included in the list of discrepancy records and determine a priority for at least one of the discrepancy records on the list of discrepancy records based on the evaluation.

### BRIEF DESCRIPTION OF THE DRAWINGS

FIG. 1 is a block diagram of an exemplary system consistent with certain disclosed embodiments;

FIG. 2 is a screenshot of an exemplary primary audit form consistent with certain disclosed embodiments;

FIG. 3 is a screenshot of an exemplary list of discrepancy records consistent with certain disclosed embodiments; and

FIG. 4 is a flow chart illustrating an exemplary process for automatically processing inventory discrepancies consistent with certain disclosed embodiments.

### DETAILED DESCRIPTION

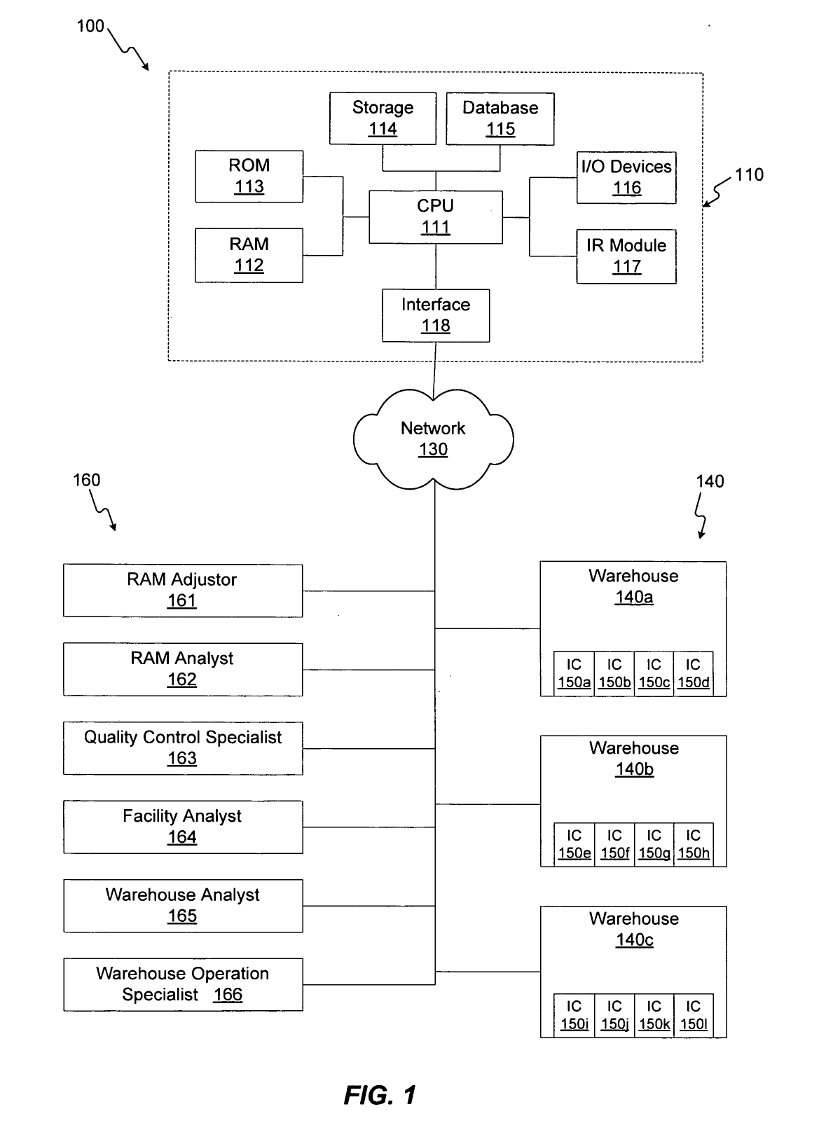

FIG. 1 illustrates an exemplary system architecture 100 from which systems and methods consistent with the disclosed embodiments may be implemented. As shown in FIG. 1, system architecture 100 may include one or more hardware and/or software components configured to display, collect, store, analyze, evaluate, distribute, report, process, record, and/or sort information associated with automated processing of inventory discrepancies. System architecture 100 may include inventory computing system 110, network 130, one or more warehouses 140, and one or more inventory reconciliation entities 160.

Inventory computing system 110 may be configured to receive, collect, analyze, evaluate, report, display, and distribute data related to the automated processing of inventory discrepancies using one or more hardware and/or software components such as, for example, a central processing unit (CPU) 111, a random access memory (RAM) 112, a read-only memory (ROM) 113, a storage 114, a database 115, one or more input/output (I/O) devices 116, one or more inventory reconciliation (IR) modules 117, and interface 118. Inventory computing system 110 may be a server, client, mainframe, desktop, laptop, network computer, workstation, personal digital assistant (PDA), cellular phone, pager, and the like. For example, inventory computing system 110 may be a computer configured to receive and process current and historical information associated with an inventory, such as inventory discrepancies. Inventory computing system 110 may also be configured to process, prioritize, categorize, resolve, and communicate inventory discrepancies and/or inventory discrepancy records. In addition, one or more constituent components of inventory computing system 110 may be co-located with any one or more warehouses 140, and/or inventory computing system 110 may be located separately from warehouses 140.

CPU 111 may include one or more processors, each configured to execute instructions and process data to perform functions associated with inventory computing system 110. As illustrated in FIG. 1, CPU 111 may be communicatively coupled to RAM 112, ROM 113, storage 114, database 115, I/O devices 116, IR modules 117, and interface 118. CPU 111 may be configured to execute computer program instructions to perform various processes and methods consistent with certain disclosed embodiments. In one exemplary embodiment, computer program instructions may be loaded into RAM 112 for execution by CPU 111. In one embodiment, IR modules 117 may be loaded into RAM 112 for execution by CPU 111.

RAM 112 and ROM 113 may each include one or more devices for storing information associated with an operation of inventory computing system 110 and/or CPU 111. For example, ROM 113 may include a memory device configured to access and store information associated with inventory computing system 110, including information for identifying, initializing, and monitoring the operation of one or more components and subsystems of inventory computing system 110. RAM 112 may include a memory device for storing data associated with one or more operations of CPU 111. For example, instructions stored on ROM 113 may be loaded into RAM 112 for execution by CPU 111.

Storage 114 may include any type of storage device configured to store any type of information used by CPU 111 to perform one or more processes consistent with the disclosed embodiments. Storage 114 may include one or more magnetic and/or optical disk devices, such as, for example, hard drives, CD-ROMs, DVD-ROMs, a universal serial bus (USB) port, a floppy, or any other type of mass media device.

Database 115 may include one or more software and/or hardware components that store, organize, sort, filter, and/or arrange data used by inventory computing system 110 and/or CPU 111. For example, database 115 may store information associated with inventory items, such as, for example, inventory quantity, inventory history, inventory location, storage container location, expected and actual storage container quantities, and the like, as well as shipments received to, from, and/or between storage container locations, warehouses, etc., that may be used by CPU 111 to receive, categorize, prioritize, save, send, or otherwise process inventory. In addition, database 115 may store additional and/or different information than that listed above.

I/O devices 116 may include one or more components configured to communicate information associated with inventory computing system 110. For example, I/O devices 116 may include a console with an integrated keyboard and mouse to allow a user to input parameters associated with inventory computing system 110 and/or data associated with inventory, inventory management, inventory discrepancies, etc. I/O devices 116 may include one or more displays or other peripheral devices, such as, for example, printers, cameras, microphones, speaker systems, electronic tablets, bar code readers, or any other suitable type of input/output devices. Alternatively and/or additionally, I/O devices 116 may include “picking” devices that may be configured to access and “pick” inventory items from one or more inventory locations, such that 110 devices 116 are at least partially automated and capable of receiving and/or transmitting information associated with inventory discrepancies.

Inventory reconciliation (IR) modules 117 may include one or more software programs, instructions, and/or listings configured to perform one or more processes consistent with the disclosed embodiments. For example, IR modules 117 may include a computer program product stored on inventory computing system 110 and configured to be executed by CPU 111 to perform one or more processes for the automated processing of inventory discrepancies.

Interface 118 may include one or more components configured to transmit and receive data via network 130, such as, for example, one or more modulators, demodulators, multiplexers, de-multiplexers, network communication devices, wireless devices, antennas, modems, and any other type of device configured to enable data communication via any suitable communication network. Interface 118 may also be configured to provide remote connectivity between CPU 111, RAM 112, ROM 113, storage 114, database 115, one or more input/output (I/O) devices 116, and/or IR modules 117 to collect, analyze, and distribute data or information associated with the automated processing of inventory discrepancies.

Inventory computing system 110 may include additional, fewer, and/or different components than those listed above and it is understood that the listed components are exemplary only and not intended to be limiting. For example, one or more of the hardware components listed above may be implemented using software. In one exemplary embodiment, storage 114 may include a software partition associated with one or more other hardware components of inventory computing system 110. Additional hardware or software may also be used to operate inventory computing system 110, such as, for example, security applications, authentication systems, dedicated communication systems, etc. The hardware and/or software may be interconnected and accessed as required by authorized users. In addition, a portion, or all of, inventory computing system 110 may be hosted and/or operated by a separate business entity, such as, for example, commercial servers and/or application providers.

Network 130 may be any appropriate network allowing communication between or among one or more computing systems, such as, for example, the Internet, a local area network, a workstation peer-to-peer network, a direct link network, a wireless network, or any other suitable communication network. Connection with network 130 may be wired, wireless, or any combination thereof.

Warehouses 140a-c may be connected to one or more other warehouses 140a-c and/or inventory computing system 110 through network 130. Warehouses 140 may include any facility used for storing or holding inventory for a business or other entity. Warehouse 140 may be a single facility or may be part of a distribution network including multiple warehouses 140a-c. For example, warehouse 140a may be a main warehouse facility and warehouses 140b and 140c may be regionally located warehouses. Additionally and/or alternatively, warehouse 140 may be co-located with a business, such that warehouse 140 may be a stockroom containing inventory for sale or use by the business. Any business that may require inventory of items may utilize the method of the disclosed embodiments, such as, for example, suppliers, vendors, wholesalers, retailers, merchants, repair shops, manufacturers, and the like, as well as any business requiring access to a supply of items. Inventory may include any quantity or type of goods or merchandise stored for any period of time, such as, for example, whole products, parts, assemblies, sub-assemblies, components, sub-components, etc. Non-limiting examples of inventory may be, for example, manufactured or manufacturing components, manufactured or manufacturing products, automobiles, water-craft (i.e., boats, ships, etc.), machines, machinery, automotive or machinery parts and supplies, engine parts and supplies, commercial products, office supplies, commercial goods including retail and/or wholesale goods, etc.

Warehouses 140a, 140b, and 140c may include one or more inventory containers (IC) 150a-d, e-h, and i-l, respectively, that may be used to store and/or hold inventory. While it is anticipated that IC 150 may contain one or more items each, it is also anticipated that IC 150 may contain no items. IC 150 may be any type of suitable storage element such as, for example, bins, shelves, containers, buckets, barrels, and the like. Warehouses 140 may also include one or more computing devices (i.e., desktop, laptop, mainframe, server, client, handheld computing device, personal digital assistant, telephony device, tablet PC, bar code reader, scanner, etc.) and various other hardware or software components (not shown). The one or more computing systems may allow warehouse 140 to connect to inventory computing system 110 by means of network 130.

One or more external and/or internal inventory reconciliation (IR) entities 160 may also be connected to inventory computing system 110 and warehouses 140 through network 130. The one or more IR entities 160 may be individuals and/or groups associated with inventory items, inventory facilities, inventory management, etc. The one or more IR entities 160 may include, for example, one or more records accuracy management (RAM) adjustors 161, who may be responsible for maintaining inventory data and discrepancy records, one or more records accuracy management (RAM) analysts 162, who may be responsible for determining and providing data associated with inventory item receipt, one or more quality control specialists 163, who may be responsible for independent tracking and verification of inventory data and discrepancy record management, one or more facility analysts 164, who may be responsible for providing data associated with the inventory items and discrepancy records, one or more warehouse analysts 165, who may require access to portions of the inventory item data and discrepancy records, one or more warehouse operation specialists 166, who may be responsible for maintaining data records for themselves and warehouse analysts 165, and the like. In one embodiment, inventory adjustors may have overall responsibility for ensuring reconciliation of inventory discrepancies. In another exemplary embodiment, facility analysts, warehouse analysts, and warehouse operations specialists may be associated with a specific warehouse 140. In addition, there may be additional or different entities than those disclosed above such as, for example, transportation specialists, management specialists, vendor specialists, and the like.

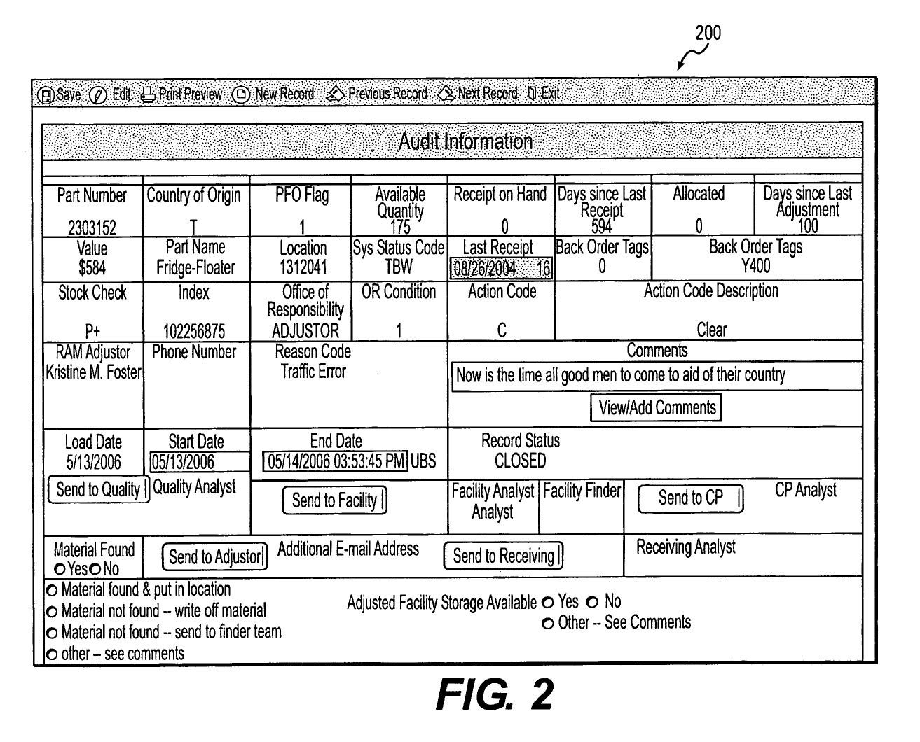

IR modules 117 may use one or more electronic forms to perform one or more processes consistent with the disclosed embodiments. One exemplary electronic form, shown in FIG. 2, may be primary audit form 200. Primary audit form 200 may be used to provide a template through which the one or more IR entities 160 may interact and/or communicate with inventory computing system 110 and each other. That is, primary audit form 200 may include stored values downloaded from database 115, and IR entities 160 may enter, update, and view data associated with individual discrepancy records through the primary audit form 200. Discrepancy records that have been edited through primary audit form 200 may be stored in database 115 and viewed by one or more other IR entities 160. In addition, the one or more IR entities 160 may use primary audit form 200 to communicate status and reconciliation progress associated with the discrepancy record to inventory computing system 110 and one or more other IR entities 160. The format and configuration of primary audit form 200 is exemplary and not intended to be limiting.

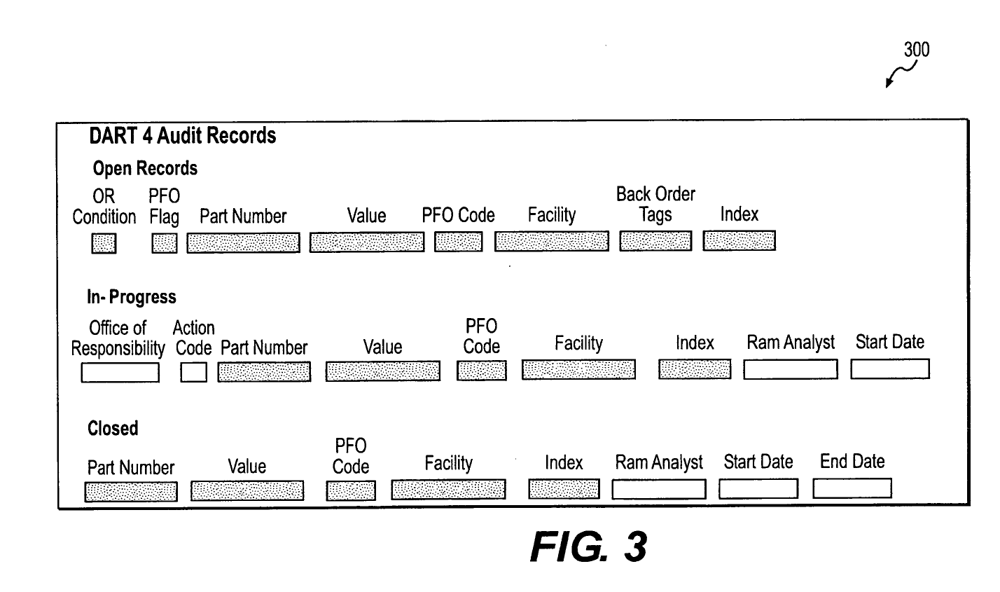

IR modules 117 may compile one or more discrepancy records into a list of discrepancy records 300, as shown in FIG. 3. The list of discrepancy records 300 may be displayed and viewed by one or more IR entities 160. In one exemplary embodiment, RAM analysts 162 may use the list of discrepancy records 300 to display, track, organize, and communicate one or more discrepancy records. The format and configuration of the list of discrepancy records 300 is exemplary and not intended to be limiting.

IR modules 117 may utilize additional electronic forms including an activity code form (not shown), a reason code form (not shown), an office of responsibility code form (not shown), and the like. In one embodiment, the additional electronic forms may not be directly viewable by a user. Instead, the codes stored in the additional electronic forms may be accessible through primary audit form 200 by means of look-up tables, pull-down menus, and the like.

The activity code form may be used to store, display, and access activity codes associated with the discrepancy records. In one embodiment, the activity codes may be displayed as alphanumeric values in the “action code” field and may indicate an expected or desired actions associated with the resolution of the discrepancy records. Exemplary activity codes may include, for example, on hold (H), adjust (A), recount (R), on hold turned on sourcing (S), clear (C), and the like. Additional and/or alternative activity codes (e.g., numerical values, color graphics, symbols, voices, sounds, etc.) may be used and this list is not intended to be limiting.

The reason code form may be used to store, display, and access reason codes associated with a current status of the discrepancy record. In one embodiment, the reason codes may be alphanumeric values indicating a reason for the current status of the associated discrepancy record. Exemplary reason codes may include dealer return write off, quality control or scrap due to process error, traffic error, reverse previous adjustment, lost in transit, allocate pick exception, lost material, lost receipt, receipt reconciliation change notice, receipt discrepancy notice, and the like. Additional and/or alternative reason codes (e.g., numeric values, color graphics, symbols, voices, sounds, etc.) may be used and this list is not intended to be limiting.

The office of responsibility condition code form may be used to store, display, and access codes associated with an assigned office of responsibility (e.g., the office responsible for resolution of the discrepancy record). In one embodiment, the office of responsibility condition codes may be alphanumeric values and may be automatically entered into the discrepancy record based upon activities or events within a discrepancy record. Exemplary office of responsibility condition codes may include, for example, directions to send, load, or transfer information contained in the discrepancy record to any one or more IR entities 160. In addition, any one or more office of responsibility codes may be used to trigger automated activities including, for example, generating electronic alerts or notifications, prioritization of the discrepancy record, and the like. Activities or events that may trigger automatic entry of the office of responsibility condition code may include, for example, the identity of the entity opening, viewing, and/or editing the discrepancy record, and the like. Additional and/or alternative office of responsibility condition codes (e.g., numeric values, color graphics, symbols, voices, sounds, etc.) may be used and this list is not intended to be limiting.

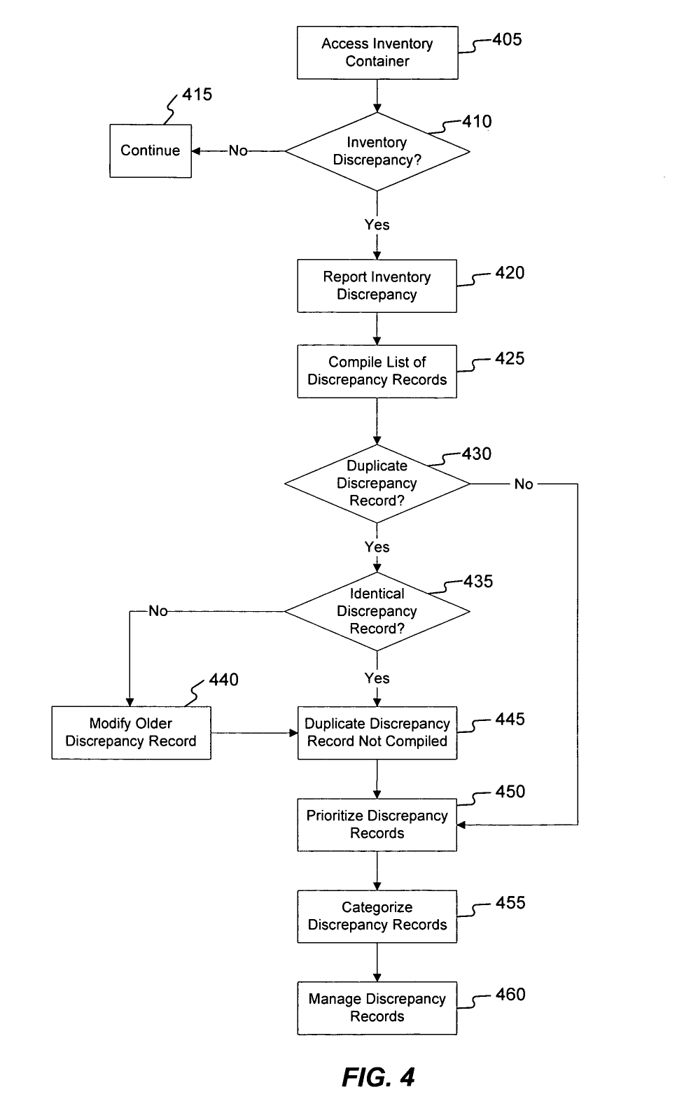

FIG. 4 illustrates a flowchart of an exemplary process for the automated processing of inventory discrepancies consistent with certain disclosed embodiments. The process of FIG. 4 may be performed by inventory computing system 110. For example, inventory computing system 110 may execute one or more software programs, such as IR modules 117, that may perform one or more process steps of FIG. 4.

As shown in step 405, an inventory container 150a, may be accessed and inventory items contained therein may be evaluated to determine an actual physical quantity. The evaluation may be made using any method and/or means of measuring an inventory quantity, such as, for example, a count, a weight, a volume, and the like. Evaluation may be made automatically and/or manually. The results of the evaluation may be entered into an electronic tool, such as, for example, a scanner, a bar code reader, a scale or electronic measuring tool, a personal digital assistant, a handheld computing device, and the like. Inventory container 150 may be accessed manually or, alternatively, inventory container 150 may be accessed automatically, e.g., by means of a picking device and the like. A picking device may be an electronically-controlled device configured to automatically access inventory locations and retrieve a quantity of inventory items.

The actual physical quantity may be compared to an expected quantity to determine if a discrepancy exists (step 410). The expected quantity may be a value maintained by database 115 and may reflect an expected quantity of inventory items determined through standard inventory management techniques. If there is no discrepancy, e.g., the actual physical quantity is the same as the expected quantity, then inventory access may continue (step 415).

If, however, there is a discrepancy and the discrepancy falls within the acceptable range of values, the expected quantity may be updated to reflect the actual physical quantity and inventory access may continue (step 415). When inventory access continues, a desired quantity of inventory items may be removed from inventory container 150 and the expected quantity contained in database 115 may be updated to reflect the removal of a quantity of inventory items. In either case, data associated with the inventory access may be retained within database 115. The data may include for example, date and time of access, bin number or location, warehouse identity or location, actual physical quantity contained in the inventory location, quantity removed, and the like.

If a discrepancy exists, e.g., the actual inventory quantity is either more or less than the expected quantity or outside the acceptable range of values, the discrepancy may be reported to inventory computing system 110 (step 420). Using the reported discrepancy information, a discrepancy record may be created. The created discrepancy record may be a text or binary file and may be stored in database 115. The discrepancy record may be parsed by IR modules 117 to enable user-interaction such that a user may display and edit the discrepancy record using primary audit form 200. The discrepancy record may contain information such as, for example, the date and time of access to the inventory container, inventory container location, warehouse location or identity, inventory item part number, actual physical quantity found in the inventory location, expected inventory quantity, and the like.

In addition, IR modules 117 may access database 115 to retrieve data and may store the retrieved data into the discrepancy record. The retrieved information may include, for example, inventory item value, back order information, discrepancy record index value, condition values, comments, etc. In some embodiments, additional data may be retrieved and entered into the discrepancy record including, for example, inventory shipment history, inventory shipment quantities, misdirected shipment data, misplaced stock data, inventory location access history, inventory adjustment history, and the like.

IR modules 117 may be configured to automatically compile one or more discrepancy records to generate a list of discrepancy records 300, as shown in FIG. 3 (step 425). The list of discrepancy records 300 may be compiled based on a predetermined event (e.g., regularly scheduled time intervals, specified number of discrepancy records having a certain priority, discrepancy records for inventory items having a specified dollar amount, sales volume, and/or velocity [i.e., rate at which an item is sold], etc.). In one exemplary embodiment, IR modules 117 may compile a list of discrepancy records 300 on a daily basis. In another embodiment, IR modules 117 may compile a list of discrepancy records 300 every 3 hours when a discrepancy record associated with a high value inventory item is included in the list of discrepancy records 300. Alternatively and/or additionally, IR modules 117 may compile a list of discrepancy records when prompted, requested, instructed, or otherwise directed by IR entities 160. IR entities 160 may open and view the list of discrepancy records 300. In addition, IR entities 160 may select one or more discrepancy records from the list of discrepancy records 300 for viewing or editing. A selected discrepancy record may be displayed using primary record form 200. As shown in FIG. 3, primary record form 200 may display an expanded set of discrepancy record data for a single discrepancy record, whereas the list of discrepancy records 300 may display a subset of discrepancy record data for a number of discrepancy records.

Compilation of the list of discrepancy records 300 may include evaluating the discrepancy records against each other to determine if there are one or more duplicate discrepancy records (step 430). Duplicate discrepancy records may be identified by comparing certain fields contained in the discrepancy record such as, for example, part number, facility code, country of origin, and the like. If two or more discrepancy records are found to contain duplicated data in the certain data fields, then the discrepancy records are determined to be duplicates. If no duplicate discrepancy records are found, processing may proceed to step 450.

If duplicate discrepancy records are found (step 430, Yes), IR modules 117 may evaluate the duplicate discrepancy records to determine if they are identical (step 435). Duplicate discrepancy records are determined to be identical if all fields in each of the one or more duplicate discrepancy records are the same. If the duplicate discrepancy records are determined to be identical (step 435, Yes), IR modules 117 will include only one of the duplicated discrepancy records in the compiled list of discrepancy records 300 (step 445). In some embodiments, the more recently created and/or opened discrepancy records may not be compiled into the list of discrepancy records 300.

If two or more discrepancy records are found to be duplicated but are not identical (step 435, No), then IR modules 117 may determine that the newer discrepancy record is more accurate. Two or more discrepancy records may be determined to be duplicated but not identical if one or more of the fields are different, such as, for example, the date, the reporting entity, the actual physical quantity, and the like. If such is the case, IR modules 117 may modify the older discrepancy record to reflect the data contained in the newer discrepancy record (step 440). In addition, IR modules 117 may compile only one of the discrepancy records into the list of discrepancy records 300 (step 445). For example, IR modules 117 may not compile the newer discrepancy record into the list of discrepancy records 300. In one exemplary embodiment, data modified in the older discrepancy record may include, for example, quantity on hand, quantity allocated, inventory item value, inventory item location, back order tags, discrepancy record index value, and office of responsibility. In addition, a notation may be added to the modified discrepancy record to document the changes. The notation may automatically include, for example, the date and time of the modification.

IR modules 117 may prioritize one or more discrepancy records on the list of the discrepancy records 300 (step 450). Prioritization may include assigning a working priority based on one or more predetermined criteria. The criteria may include, for example, inventory item sales volume and/or velocity, inventory item type and/or value, inventory location and/or facility, a revenue value associate with the inventory item, and the like. In one embodiment, prioritization may be indicated by the order of discrepancy records in the list of discrepancy records 300. Alternatively and/or additionally, priority may be indicated by flags, colors, alerts, or any other mechanism or format for indicating priority or urgency. These mechanisms or formats for indicating priority or urgency may appear in the list of discrepancy records 300 and/or the primary audit form 200. In some embodiments, discrepancy records may be prioritized by one or more IR entities 160. Additionally, IR modules 117 may selectively include discrepancy records on the list of discrepancy records 300 based on priority. For example, IR modules 117 may include only discrepancy records having the highest priority on the list of discrepancy records 300. Alternatively and/or additionally, IR modules 117 may include only a specific number of discrepancy records in the list of discrepancy records 300 based on priority. For example, IR modules 117 may include only the five highest priority discrepancy records and/or only the five highest priority discrepancy records in a specified category or number of categories.

Based on the assigned priority, IR modules 117 may automatically perform additional alert actions, such as, for example, generate and send electronic alerts and/or notifications, generate and display messages and/or pop-up boxes, and the like. Discrepancy records having the highest priority may cause IR module 117 to generate and send more frequent alerts, whereas discrepancy records having a lower priority may cause IR modules 117 to generate and send less frequent alerts. IR modules 117 may not send out alerts for discrepancy records having the lowest priority. In one embodiment, IR modules 117 may identify discrepancy reports associated with inventory items having a high sales volume to be the highest priority and IR modules 117 may send out daily electronic notifications to one or more IR entities 160.

IR modules 117 may categorize the discrepancy records according to some status (step 455). In one embodiment, exemplified in the list of discrepancy records 300, categorization may include organizing the discrepancy records according to a status of the individual discrepancy records. In addition, categorization may include displaying different data fields in the list of discrepancy records 300 based on the status of the discrepancy record. Exemplary statuses may include, for example, open, in progress, closed, and the like. A discrepancy record with a status of “open” may be a discrepancy record that has been created, but upon which no action has been taken towards resolution. A discrepancy record with a status of “in progress” may be a discrepancy record for which, at a minimum, a start date has been entered and a responsible party assigned. A discrepancy record with a status of “closed” may indicate that the underlying inventory discrepancy has been resolved. Resolution may be indicated by the entry of a value in the “end date” field of the discrepancy record and/or an activity code of “clear.” A discrepancy record may be determined to be resolved if it is determined that the inventory discrepancy requires no further action. Resolution may include, for example, determining the location of missing inventory items, determining the cause of the inventory discrepancy, adjusting the expected quantity to reflect the actual quantity without determining a cause, and the like.

In addition, IR modules 117 may be configured to automatically manage the one or more discrepancy records stored in database 115 as the discrepancy records are processed (step 460). IR modules 117 may manage the discrepancy records based on data values stored in the discrepancy records. For example, IR modules 117 may evaluate one or more fields in the discrepancy record and, based on the data values stored in the fields, may automatically perform predetermined actions. In addition to compiling the list of discrepancy records and prioritizing the discrepancy records, IR modules 117 may perform other predetermined actions. For example, notifying one or more IR entities 160 of required and/or expected actions, sending electronic notifications to one or more IR entities 160, sending electronic alerts and reminder to IR entities 160, inputting data into one or more fields of the discrepancy records, determining a required or desired next action towards resolution of the inventory discrepancy, controlling access and/or visibility to individual discrepancy records or the list of discrepancy records 300, controlling access and/or visibility to primary audit form 200, controlling access and/or visibility to fields in the discrepancy record, and the like.

As discussed above, IR modules 117 may be configured to control access to primary audit form 200, the list of discrepancy records 300, and one or more discrepancy records. In addition, IR modules 117 may control access to fields, buttons, etc. within primary audit form 200. IR modules 117 may control access using a data field in the discrepancy record such as, for example, reason code, office of responsibility condition code, etc. For example, IR modules 117 may restrict access to discrepancy records based on a facility code, such that only a designated entity or person, such as a facility analyst 164 for the designated facility, may view the discrepancy record. Alternatively and/or additionally, IR modules 117 may control access based on the identity of the entity viewing the primary audit form. For example, IR modules 117 may restrict access to the buttons labeled, “Send to Quality,” “Send to Facility,” and/or “Send to Receiving” such that only RAM adjustor 161 is able to select them.

Additionally, IR modules 117 may control activation of one or more buttons in the primary audit form 200 and allow editing or entry of data based upon the status of the discrepancy record. For example, IR modules 117 may enable activation of buttons and/or editing of data when the discrepancy record status is open or in progress. IR modules 117 may disable activation of buttons and not allow editing or entry of data when the discrepancy record status is closed. For instance, when a discrepancy record is created, IR modules 117 may set the status to “open” and then automatically generate and send one or more notifications to one or more IR entities 160. IR modules 117 may automatically determine the recipients of the notification based on data contained in one or more data fields of the discrepancy record, such as, for example, inventory item number (e.g., part number), inventory item value, inventory item type, country of origin, quantity, days since discrepancy report created, facility, warehouse, and the like. Notification may be made electronically using any well-known means, such as, for example, electronic mail, instant message, electronic page, telephony contact, and the like.

Once the status of a discrepancy record is open, one or more fields of the discrepancy record may be available for editing or entry of data, including editing of existing data, entry of new data, deletion of data, etc. In one exemplary embodiment, an open discrepancy record may have a number of data fields available for viewing and/or sorting, such as, for example, fields for office of responsibility, activity code (i.e., action code), inventory item number, inventory item value, parts of foreign origin flag, parts of foreign origin code, facility identifier (e.g., warehouse, etc.), number of back order tags, discrepancy record index number, start date, and the like.

IR modules 117 may automatically evaluate one or more data fields in the discrepancy record to determine one or more further actions. For example, if the “start date” field is selected in an open discrepancy report, the current date and time may be automatically entered. In addition, responsibility for the discrepancy record may be assigned and the associated data may be automatically entered or updated, including, for example, name and phone number of a responsible party, as well as an office of responsibility. The office of responsibility may be one of the IR entities 160, and may indicate the office currently responsible for one or more actions toward resolution of the discrepancy record. The responsible party may be one or more individuals within the office of responsibility assigned to track resolution of the inventory discrepancy. Once a date and time has been entered into the “start date” field, the status of the discrepancy record may be automatically changed from “open” to “in progress.”

When the status of the discrepancy record is “in progress,” it may indicate that, at a minimum, a start date has been entered and a responsible party has been assigned. This may be considered the first step towards resolution of the inventory discrepancy. A discrepancy record having a status of in progress may remain in progress until the inventory discrepancy has been resolved

Similarly to open discrepancy records, IR modules 117 may evaluate one or more fields of “in progress” discrepancy records and, based on the evaluation, may perform additional processing. In one embodiment, IR modules 117 may evaluate an activity code value, an office of responsibility condition code value, and the like to determine if additional processing is to be performed. For example, if the office of responsibility condition code value is equal to 5, IR modules 117 may send an automatic notification to quality control specialists 163. However, if the office of responsibility condition code value is equal to 1, IR modules 117 may send an automatic notification to RAM analysts 162. In addition, IR modules 117 may evaluate the office of responsibility condition code to determine if the discrepancy record is to be compiled in the list of discrepancy records 300.

Once the IR entity 160 receives and responds to a notification, IR module 117 may be configured to automatically perform further actions. In one embodiment, IR modules 117 may evaluate an activity code data field. Based on the data contained in the activity code data field, IR modules 117 may automatically send electronic notifications to one or more IR entities 160. For example, if the activity code data field indicates “recount,” an electronic notification may be sent automatically to warehouse operations specialist 166 requesting a recount of the specified inventory item.

Once the recount has been completed, warehouse operations specialist 166 may open the discrepancy record using primary audit form 200 and may indicate that the recount has been completed and provide the results of the recount. For example, warehouse operations specialist 166 may indicate that the quantity of inventory items has changed by editing the quantity field. Additionally, warehouse operations specialist 166 may provide comments in the comment field. IR modules 117 may then send an electronic notification to RAM adjustor 161 to indicate the recount has been completed. As another example, if the inventory discrepancy is resolved, e.g., the missing inventory items are found, warehouse operations specialist 166 may select the appropriate buttons in the primary audit form 200, e.g., warehouse operations specialist 166 may select the “Yes” radio button in the field labeled “Material Found.” In addition, warehouse operations specialist 166 may then select the button labeled “Send to Adjustor.” IR modules 117 may record data associated with the selection of the radio button, including radio button identity, date of entry, time of entry, identity of warehouse operations specialist 166, and the like. In addition, IR modules 117 may be configured to automatically send notification based on selection of one or more buttons or other selectable area within primary audit record 200. For example, if the “Send to Adjustor” button is selected, IR module 117 may send an automatic notification to RAM adjustor 161. If the “Send to Facility” button is selected, IR module 117 may send an automatic notification to facility analyst 164. This process may continue until the discrepancy record is determined to be resolved and the status of the discrepancy record is “closed.”

IR modules 117 may continue to include closed discrepancy records in the list of discrepancy reports 300 for a predetermined period of time, e.g., one year, six months, one month, etc. Once the predetermined period of time has passed, IR modules 117 may archive closed discrepancy records. Archiving closed discrepancy records may include compressing and storing the data contained within the discrepancy records, using, for example, any suitable mass media storage device. In some embodiments, archiving may be done using off-site archiving facilities and/or utilities.

### INDUSTRIAL APPLICABILITY

The disclosed embodiments may be implemented with automated processing of inventory discrepancies. The disclosed embodiments may achieve improved processing for inventory discrepancy reconciliation. In particular, the disclosed embodiments may provide improved data input, tracking, and auditing of inventory discrepancies and inventory discrepancy records.

The disclosed embodiments may be applicable to any type of goods including retail items, wholesale items, and/or consumer goods. In addition, the disclosed embodiments may be used within a business entity or among multiple business entities. The business entity may include divisions, groups, etc. that interact as sub-entities for the business entity. The sub-entities may act as a user of a good supplied by a supplier sub-entity within the same business entity, such as a manufacturing business with supply division, production line division, etc.

It will be apparent to those skilled in the art that various modifications and variations can be made in the inventory discrepancy processing method. It is intended that the specification and examples be considered as exemplary only, with a true scope of the disclosed embodiments being indicated by the following claims and their equivalents.

1. A method for automated processing of inventory discrepancies, comprising:
accessing an inventory location to determine an actual quantity of an inventory item;
accessing an inventory management tool to determine an expected quantity of the inventory item;
identifying an inventory discrepancy between the expected quantity of the inventory item and the actual quantity of the inventory item;
generating a discrepancy record based on the inventory discrepancy, wherein the discrepancy record includes a plurality of data fields;
evaluating one or more of the plurality of data fields; and
determining a priority for the discrepancy record based on the evaluation by;
evaluating data associated with a sales volume for the inventory item; and
determining the priority for the discrepancy record based on the data associated with the sales volume.

2. (canceled)

3. The method as in claim 1, further including:
generating one or more actions based on the priority.

4. The method as in claim 3, wherein the one or more actions includes:
automatically generating an electronic notification to one or more entities.

5. The method as in claim 1, further including:
generating a list of discrepancy records, wherein the list of discrepancy records includes one or more discrepancy records.

6. The method as in claim 5, wherein generating the list of discrepancy records includes:
providing an indication of priority for each of the discrepancy records on the list of discrepancy records.

7. The method as in claim 1, further including:
updating a status associated with the discrepancy record, wherein the status is updated automatically; and
tracking the discrepancy record until one or more predetermined criteria are met, wherein the one or more predetermined criteria includes the status.

8. The method as in claim 5, wherein generating the list of discrepancy records includes:
automatically generating the list of discrepancy records based on data associated with a predetermined event.

9. The method as in claim 1, wherein determining the priority includes:
automatically determining the priority based on data associated with a sales volume.

10. A computer-readable medium including instructions for performing a method, when executed by a processor, for automated processing of inventory discrepancies, the method comprising:
accessing an inventory location to determine an actual quantity of an inventory item;
accessing an inventory management tool to determine an expected quantity of the inventory item;
identifying an inventory discrepancy between the expected quantity of the inventory item and the actual quantity of the inventory item;
generating a discrepancy record based on the inventory discrepancy, wherein the discrepancy record includes a plurality of data fields;
evaluating one or more of the plurality of data fields; and
determining a priority for the discrepancy record based on the evaluation by;
evaluating data associated with a sales volume for the inventory item, and
determining the priority for the discrepancy record based on the data associated with the sales volume.

11. (canceled)

12. The computer-readable medium of claim 10, wherein the method further includes:
generating one or more actions based on the priority.

13. The computer-readable medium of claim 12, wherein the one or more actions includes:
automatically generating an electronic notification to one or more entities.

14. The computer-readable medium of claim 10, wherein the method further includes:
generating a list of discrepancy records, wherein the list of discrepancy records includes one or more discrepancy records.

15. The computer-readable medium of claim 14, wherein generating the list of discrepancy records includes:
providing an indication of priority for each of the discrepancy records on the list of discrepancy records.

16. The computer-readable medium of claim 10, wherein the method further includes:
updating a status associated with the discrepancy record, wherein the status is updated automatically; and
tracking the discrepancy record until one or more predetermined criteria are met, wherein the one or more predetermined criteria includes the status.

17. The computer-readable medium of claim 14, wherein generating the list of discrepancy records includes:
automatically generating the list of discrepancy records based on data associated with a predetermined event.

18. The computer-readable medium of claim 10, wherein determining the priority includes:
automatically determining the priority based on data associated with a sales volume.

19. A system for automated processing of inventory discrepancies, the inventory discrepancy reflecting a difference between an expected quantity of an inventory item and an actual quantity of the inventory item, comprising:
at least one memory storing data and instructions; and
at least one processor configured to access the memory and configured, when executing the instructions, to:
generate a discrepancy record based on the inventory discrepancy, wherein the discrepancy record includes a plurality of data fields, and wherein the actual quantity of the inventory item is determined by accessing an inventory location and the expected quantity of the inventory item is determined by accessing an inventory management tool,
generate a list of discrepancy records, wherein the list of discrepancy records includes one or more discrepancy records,
evaluate one or more of the plurality of data fields for each of the discrepancy records included in the list of discrepancy records, and
determine a priority for at least one of the discrepancy records on the list of discrepancy records based on the evaluation by:
evaluating data associated with a sales volume for the inventory item, and
determining the priority for the discrepancy records based on the data associated with the sales volume.

20. The system of claim 19, wherein the processor is further configured to:
generate, based on the determined priority, at least one electronic notification to one or more entities.
